(19) United States
(12) Patent Application Publication
(10) Pub. No.: US 2002/0147968 A1
(43) Pub. Date: Oct. 10, 2002

(54) Method for emulating a program-controlled unit

(76) Inventors: Jens Barrenscheen, Munchen (DE); Werner Pichl, Eching (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/116,156

(22) Filed: Apr. 4, 2002

(30) Foreign Application Priority Data
Apr. 4, 2001 (DE) 101 16 864.0

(51) Int. Cl. G06F 9/44

(52) U.S. Cl. 717/134

(57) ABSTRACT

A method for emulating a program-controlled unit, in which an application program executed by the program-controlled unit can be interrupted in order to execute a debug sequence by which actions that are useful or required for the emulation are executed. The method is distinguished by the fact that the execution of the debug sequence is initiated by the application program. As a result, even program-controlled units that are used for time-critical applications can be emulated as desired and without disrupting the system containing the program-controlled unit.

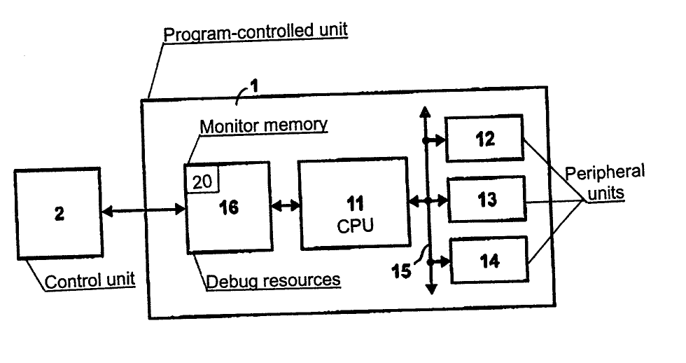

### BACKGROUND OF THE INVENTION

### FIELD OF THE INVENTION

The present invention relates to a method for emulating a program-controlled unit, in which an application program being executed by the program-controlled unit can be interrupted in order to execute a debug sequence by which actions that are useful or required for the emulation are executed.

Program-controlled units such as microprocessors, microcontrollers, signal processors, etc. have been known in innumerable embodiments for many years and need no further explanation.

The emulation of a program-controlled unit of this or of another type serves for identifying, localizing and eliminating errors that occur in the program-controlled unit, or in the system containing the program-controlled unit.

The emulation is effected using an emulator that contains a special version—suitable for the emulation—of a program-controlled unit and a control unit which controls the emulation. During the emulation, the program-controlled unit contained in the emulator replaces the program-controlled unit of the system to be examined. The control unit is able, in interaction with debug resources present in the program-controlled unit, to identify the occurrence of predetermined states or events and to react to the occurrence of the states or events in a likewise predetermined manner.

The predetermined states or events consist, for example, in specific data, addresses or control signals that are being transferred or stored within or outside the program-controlled unit.

The predetermined reactions to the occurrence of such states or events or to other states or events include, for example, stopping the program-controlled unit, stopping the read-out and/or the alteration of the contents of registers or internal or external memories, and/or stopping the recording and evaluation of the profiles—occurring beforehand and/or afterward—of data, addresses, signals of interest, and/or register and memory contents.

The basic construction of an emulator that is able to do this is shown in the sole drawing figure. For the sake of completeness, it shall be noted that only the components of the emulator which are of particular interest in the present case are shown in the figure.

The emulator includes a program-controlled unit 1 and a control unit 2 that controls the emulation.

The program-controlled unit 1 includes a CPU 11, peripheral units 12, 13 and 14 such as, for example, timer, A/D converter, memory, etc., a bus 15 connecting the CPU 11 and the peripheral units 12 to 14, and debug resources 16 connected to the CPU 11 and the control unit 2.

For the sake of completeness, it shall be noted that the program-controlled unit can include one or more semiconductor chips. In particular, the debug resources 16 can (but need not) be accommodated on a dedicated semiconductor chip; such a program-controlled unit is described in DE 197 432 64 A1.

During the emulation, the program-controlled unit executes the application program that is to be executed in normal operation of the system to be examined. In this case, the debug resources 16 and the control unit 2 monitor the occurrence of specific states or events and perform the actions mentioned in the introduction or other actions that are useful or required for the identification, localization and elimination of errors.

The debug resources 16 are controlled by the control unit 2. The debug resources 16 contain components that are required in order to perform the actions required for the emulation.

The components of the debug resources 16 may include, for example:

a control device that can control the remaining components of the debug resources 16 and also components of the program-controlled unit that are provided outside the debug resources;

a breakpoint, watchpoint or trigger logic that monitors when states or events occur that require reacting by executing the actions mentioned in the introduction or other actions;

a memory, referred to below as a monitor memory 20, in which debug sequences are stored that must be executed in the CPU 11 to be able to execute specific actions (for example reading-out or altering register contents);

a memory referred to below as an overlay memory, in which programs are stored that can be executed, for example, for testing the effects of changes in the application program, the programs stored in the overlay memory are used instead of the application program that is stored in the program memory of the program-controlled unit; and

a so-called trace bus for continuously outputting data, addresses, signals of interest, and/or register and memory contents to the control unit 2.

The emulator makes it possible, in diverse ways, to identify, localize and eliminate errors that occur in the program-controlled unit or in the system containing the program-controlled unit.

However, experience shows that it is not possible or it is only possible with great difficulty to seek, localize, and eliminate errors in time-critical applications. This is the case, for example, if the program-controlled unit must control an electric motor (e.g. an AC motor). If, in this case, the motor control program that is executed by the CPU is interrupted in order to execute one of the debug sequences stored in the monitor memory (for example the debug sequence which must be executed in order to read out or alter register or memory contents), then it can happen that the motor is no longer driven correctly and the system no longer behaves in the usual manner (under normal conditions).

### SUMMARY OF THE INVENTION

It is accordingly an object of the invention to provide a method for emulating a program-controlled unit which overcomes the above-mentioned disadvantages of the prior art methods of this general type.

In particular, it is an object of the invention to provide a method for emulating a program-controlled unit in which, in time-critical applications, an application program executed by the program-controlled unit can be interrupted in order to execute a debug sequence performing actions that are useful or required for emulating the program-controlled unit.

With the foregoing and other objects in view there is provided, in accordance with the invention, a method for emulating a program-controlled unit that includes steps of: executing an application program with the program-controlled unit; using the application program to initiate executing a debug sequence performing actions relating to emulating the program-controlled unit, the actions being selected from the group consisting of being actions useful for the emulating and being actions required for the emulating; and interrupting the application program while performing the step of executing the debug program.

In accordance with an added feature of the invention, the application program being executed by the program-controlled unit during the emulating includes debug sequence calls.

In accordance with an additional feature of the invention, the method includes storing debug sequences that are called by a modified application program in a monitor memory of the program-controlled unit.

In accordance with another feature of the invention, the method includes: using a control unit to control the emulation; and using the control unit to perform the step of storing the debug sequences in the monitor memory.

In accordance with a further feature of the invention, if the program-controlled unit is executing the debug sequence, then a signal is sent from the program-controlled unit to a control unit controlling the emulation.

The inventive method is distinguished by the fact that the execution of the debug sequence is instigated by the application program.

As a result, it can be ensured that the application program is not interrupted precisely when the application program is in a time-critical phase. Consequently, the inventive emulation method can also be employed in time-critical applications.

Other features which are considered as characteristic for the invention are set forth in the appended claims.

Although the invention is illustrated and described herein as embodied in method for emulating a program-controlled unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURE

The FIGURE sole drawing shows an emulator.

### DESCRIPTION OF THE PREFERRED EMBODIMENTS

Referring now to the sole figure of the drawing in detail, there is shown an emulator, which has previously been described. The emulation method described below makes no special requirements of the hardware. In other words, the method can be used in the arrangement described in the introduction with reference to the figure, and therefore, the method will also be described with reference to this figure.

In the case of the emulation method described here, unlike in the case of conventional emulation methods, the execution of the debug sequences is not instigated by the control unit 2 or the debug resources 16, but rather by the application program.

As will be understood even better below, making the execution of the debug sequence dependent on the occurrence of specific states or events can (but need not) be dispensed with in this case.

If the execution of the debug sequences is made dependent on the occurrence of specific states or events, these states or events may be the same states or events or different states or events than those in the case of the conventional emulation method described in the introduction.

It shall be assumed for the more detailed explanations that will now follow that the program-controlled unit is controlling a motor. The program that will be executed for this purpose is a motor control program. However, it shall already be pointed out at this juncture that there is no restriction to this. Any other desired application can also be involved, of course.

For the novel emulation method, first a program is written which, on the one hand, allows the program-controlled unit to operate in the desired application, that is to say, as a motor control device in the example considered, and which, on the other hand, instigates or initiates the execution of debug sequences in phases of the motor control program in which the motor control is not thereby disrupted, that is to say in non-time-critical phases.

The basis for such a program is the application program that will be executed in normal operation of the program-controlled unit, that is to say, the motor control program in the example considered. Instructions that call the debug sequences, which are stored in the monitor memory, are incorporated in the program. Which one of the debug sequences stored in the monitor memory is actually called depends on the particular actions that are needed in each case.

This program, referred to below as a modified application program, is executed on the CPU 11 during the emulation of the program-controlled unit instead of the (non-modified) application program that is executed in the normal operation of the program-controlled unit.

In the example considered, this is done by the control unit 2 loading the modified application program into the overlay memory, and then ensuring that the program executed by the CPU 11 is no longer loaded from the program memory that is used in the normal operation of the program-controlled unit, but rather from the overlay memory. This can be done for example by changing, in a so-called memory mapping unit, the assignment specification defining the memory device that must be accessed in order to read the data that are requested by the CPU and specified by an address. What can thereby be achieved is that, when the CPU 11 requests data stored in the program memory, it receives data stored in the overlay memory.

However, the modified program can also be written to any other desired memory, for example, to the program memory in which the programs that are to be executed by the CPU 11 are normally stored, or to any other desired internal or external memory that is accessed by the CPU.

By virtue of the execution of the application program modified in the overlay memory, the CPU 11 executes the actions that will be carried out for the application to be examined (the motor control) and furthermore also executes, as required, actions that are useful or required for the emulation, for example reading-out or altering memory or register contents.

Preferably, the program-controlled unit 1 signals, to the control unit 2, that the program-controlled unit 1 has instigated the execution of debug sequences. The signal by which this is done is referred to below as the debug sequence signal. The generation of the debug sequence signal can be realized by simple logic. This logic must merely be able to recognize that the instructions being executed by the CPU are currently being fetched from the monitor memory.

Communicating the debug sequence signal to the control unit 2 proves to be advantageous because the program-controlled unit 1 and the control unit 2 can thereby be synchronized. This makes it possible to prevent the situation:

where the control unit erases or overwrites data that are stored in the emulation resources and that are required or may be required for executing the debug sequence (for example the instruction data representing the debug sequence in the monitor memory); and

where the control unit reads out and evaluates data stored in the debug resources before the data that will be evaluated are stored there, or after the data that will be evaluated have already been erased or overwritten or are already obsolete.

In the example considered, the rising edge in the debug sequence signal signals to the control unit that the execution of a debug sequence has begun. The falling edge in the debug sequence signal signals that the execution of the debug sequence has ended (or vice versa). The control unit can then recognize from the rising edge (from the high level) of the debug sequence signal that, until further notice (until the falling edge), it is permitted to erase or overwrite no or only specific data in the debug resources, and that data that it subsequently (after the rising and before the falling edge) reads from the emulation resources and evaluates are possibly not yet or no longer the data that are actually desired to be evaluated; the control unit can recognize from the falling edge (from the low level) of the debug sequence signal that it can now again erase and overwrite data in the debug resources, and/or that it should or must immediately or at once begin to read out and evaluate data stored in the debug resources.

Consequently, a possibility has been found that even enables program-controlled units, which are used for time-critical applications, to be emulated as desired without disrupting the system containing the program-controlled unit.

The emulation method described is distinguished by the fact that the execution of (debug) sequences whose execution has hitherto been instigated exclusively by the control unit 2 and/or the debug resources 16 can now be instigated by the application program. As a result, the emulator operates with a timing prescribed by the application program. The application program determines when a particular debug sequence is called.

It is furthermore advantageous that the execution of the debug sequences is instigated by standard instructions (calls, jumps, etc.) contained in the application program. This proves to be advantageous because the software developer thus does not need to have detailed knowledge about the actions to be carried out for the emulation, however, by selecting the debug sequence that will be executed and the time of execution, the software developer can nevertheless determine at what times and for how long the application program will be interrupted.

The emulation method described in the present case is not necessarily designed as a total replacement for the conventional emulation method described in the introduction. The method can also be used together with the conventional emulation method. For certain actions, the conventional emulation method is even better suited than the novel emulation method presented here. These are the actions in the case of which, as a reaction to the occurrence of a specific state or event (detectable by the trigger logic), an action must be executed that does not require the execution of a debug sequence, that is to say, for example, the starting and/or ending of the recording of data, addresses of interest, and other signals in the trace memory. Independently of this, it would also be conceivable, by using the trigger logic during the execution of the modified application program, to monitor the occurrence of specific states or events, and depending on this, to reprogram the monitor memory, as a result of which the control unit can influence which particular debug sequence that will be executed in the event of the next debug sequence call from the modified application program.

We claim:

1. A method for emulating a program-controlled unit, which comprises:
executing an application program with the program-controlled unit;
using the application program to initiate executing a debug sequence performing actions relating to emulating the program-controlled unit, the actions being selected from the group consisting of being actions useful for the emulating and being actions required for the emulating; and
interrupting the application program while performing the step of executing the debug program.

2. The method according to claim 1, wherein: the application program being executed by the program-controlled unit during the emulating includes debug sequence calls.

3. The method according to claim 1, which comprises: storing debug sequences that are called by a modified application program in a monitor memory of the program-controlled unit.

4. The method according to claim 3, which comprises:
using a control unit to control the emulation; and
using the control unit to perform the step of storing the debug sequences in the monitor memory.

5. The method according to claim 1, which comprises: if the program-controlled unit is executing the debug sequence, sending a signal from the program-controlled unit to a control unit controlling the emulation.
